(19) United States
(12) Patent Application Publication
(10) Pub. No.: US 2018/0101037 A1
(43) Pub. Date: Apr. 12, 2018

(54) THIN-FILM ALIGNMENT LAYER PROVIDED WITH INTEGRALLY-FORMED SPACING STRUCTURES AND FORMING AN INTERMEDIATE LAYER FOR AN OPTICAL ARTICLE COMPRISING LIQUID CRYSTALS

(71) Applicants: ESSILOR INTERNATIONAL (COMPAGNIE GENERALE D'OPTIQUE), Charenton-Le-Pont (FR); NIKON CORPORATION, Minato-ku (JP)

(72) Inventors: Mathieu FEUILLADE, Tokyo (JP); Gregory TORTISSIER, Tokyo (JP)

(73) Assignees: ESSILOR INTERNATIONAL (COMPAGNIE GENERALE D'OPTIQUE), Charenton-Le-Pont (FR); NIKON CORPORATION, Tokyo (JP)

(21) Appl. No.: 15/561,386

(22) PCT Filed: Mar. 25, 2015
(86) PCT No.: PCT/IB2015/000496

§ 371 Date: Sep. 25, 2017

(51) Int. Cl. G02F 1/1337; G02F 1/1339; G02F 1/1347

(52) U.S. Cl. CPC G02F 1/1337; G02F 1/13473; G02F 1/13394

(57) ABSTRACT

A thin film forming an intermediate layer for an optical article including liquid crystals, the thin film including a main body limited by a first main surface and by a second main surface opposed to the first main surface, the first and second main surfaces both including a first zone exhibiting alignment properties for aligning liquid crystals along a predetermined alignment direction and a second zone forming spacing structures extending in projection from the first zone.

### TECHNICAL FIELD OF THE INVENTION

The invention relates to the field of optical articles comprising liquid crystals, and in particular of polarization-independent optical articles comprising liquid crystals.

More precisely the invention relates to a thin film forming an intermediate layer for an optical article comprising liquid crystals.

The invention also relates to a method for manufacturing such a thin film.

The invention finds a particularly interesting application in a spatial phase modulator comprising such a thin film to form a polarization-independent dual cell of liquid crystals.

### BACKGROUND INFORMATION AND PRIOR ART

Spatial phase modulators are known in the art as devices able to modulate the phase of an optical wave front. Polarization-independency is reached when the obtained modulation does not depend on the polarization of an input source of light impacting the spatial phase modulator at normal incidence.

Polarization-independent spatial phase modulators can be obtained with dual cells of liquid crystals. These polarization-independent spatial phase modulators generally comprise a film forming an intermediate layer, and, on each side of this film, a layer of aligned liquid crystals sandwiched against an electrode.

The article “Polarization-independent liquid crystal phase modulator using a thin polymer-separated double-layered structure written by Lin Y-H, Ren H, Wu Y-H, Zhao Y, Fang J, Ge Z and Wu S-T in volume n° 13 of Optics Express describes such a dual cell of liquid crystals. This dual cell comprises an intermediate layer made of two polymer films. These two polymer films are able to align liquid crystals in a predetermined alignment direction, and are glued together so that their respective predetermined alignment directions are perpendicular to one another.

In this dual cell, the thickness of the layers of liquid crystals sandwiched against each electrode is controlled by silica (or polymer) beads spread in each layer of liquid crystals.

However, the device described in this document presents the following drawbacks.

First, the manufacture of this device as a whole, and of the intermediate layer in particular, is complicated and requires many steps.

Thus, several parameters, namely, the thickness of the film forming the intermediate layer, the alignment of liquid crystals in said predetermined alignment directions and the thickness of each layer of liquid crystals are not precisely controlled. As a consequence, the polarization-independency of the device is not precisely controlled.

In particular, it is difficult to provide both polymer films with exactly the same thickness. Yet, if they do not have the same thickness, the intermediate layer will show birefringence properties, thus leading to a loss of polarization-independency.

Moreover, it is very difficult to glue the two polymer films together, with their respective aligning directions precisely perpendicular to one another, and with an even global thickness of the intermediate layer.

It also appears challenging to obtain an even thickness for each layer of liquid crystals when beads are used as spacers. Indeed, one cannot ensure the position of each bead in the layer of liquid crystals (and beads can move), thus leading to a random distribution of the beads which may result in a wavy layer.

The beads themselves may also exhibit a size distribution.

This phenomenon is all the more true when the layers of liquid crystals tend to be thicker, and when the film forming the intermediate layer tends to be thinner. Once again, polarization-independency is at risk with uneven thicknesses in the layers of liquid crystals.

A second drawback is due to the fact that the film is rather thick as it is made of two polymer films. This is all the more problematic when a voltage should be applied between the two electrodes of the dual cell; as such applied voltage must be stronger when the film gets thicker.

### SUMMARY OF THE INVENTION

Therefore one object of the invention is to provide a multifunction thin film forming an intermediate layer for an optical article comprising liquid crystals. The thin film according to this invention is able, all at once, to align liquid crystals in one direction on one side, to align liquid crystals in another direction on the other side, and to provide a precise thickness to the layers of liquid crystals comprised in the optical article. Moreover, the thin film according to the invention itself exhibits a precisely controlled thickness and no birefringence properties.

The above object is achieved according to the invention by providing a thin film forming an intermediate layer for an optical article comprising liquid crystals, comprising a main body limited by a first main surface and by a second main surface opposed to the first main surface, said first and second main surfaces both comprising a first zone exhibiting alignment properties for aligning liquid crystals along a predetermined alignment direction and a second zone forming spacing structures extending in projection from the first zone.

Thus, the thin film shows, at once, aligning properties for aligning liquid crystals on both sides, and spacing properties for ensuring even layers of liquid crystals in the optical article, on both sides. The position and size of the spacing structures of the second zones being predetermined and precisely controlled, it ensures a good control of the thickness of each layer of liquid crystals.

The thin film according to this invention is simple to use and makes the manufacture of spatial phase modulators easier.

Other characteristics of the thin film according to this invention are the following:
the first zone of the first main surface aligns liquid crystals along a first predetermined alignment direction, and the first zone of the second main surface aligns liquid crystals along a second predetermined alignment direction different from the first predetermined alignment direction;
the first zone of at least one of said main surfaces comprises nanostructures having an elongated shape along the corresponding predetermined alignment direction;
said nanostructures are shaped as straight walls extending longitudinally along the corresponding predetermined alignment direction;
the nanostructures height in a direction perpendicular to a median plane of the main body ranges from 5 nanometers to 500 nanometers, preferably from 10 nanometers to 200 nanometers;
the nanostructures are spaced apart from each other by a distance ranging from 100 nanometers to 2 micrometers;
the alignment properties of the first zone of at least one of said first and second main surfaces are obtained by rubbing said first zone along the corresponding predetermined alignment direction;
the spacing structures of the second zone are shaped as straight walls or pillars;
the spacing structures height in a direction perpendicular to a median plane of the main body ranges from 1 micrometer to 100 micrometers, preferably from 5 micrometers to 50 micrometers, more preferably from 10 micrometers to 30 micrometers;
the ratio between the surface occupied by the first zone to the surface occupied by the spacing structures ranges from 1 to 200, preferably from 5 to 60;
the main body is made of a single piece of polymer material.

A further object of the invention is to provide a method for manufacturing with ease a thin film according to the invention.

The above object is achieved according to the invention by providing a method for manufacturing a thin film according to the invention, comprising the following steps:

a) providing a main body with first and second main surfaces,

b) providing first and second main surfaces with spacing structures, thereby defining the second zone of said first and second main surfaces,

c) providing the part of the first and second main surfaces located between said spacing structures with alignment properties for aligning liquid crystals, thereby defining the first zone of said first and second main surfaces.

Other characteristics of the method for manufacturing the thin film according to this invention are the following:
steps a) and b) are achieved simultaneously by embossing a polymer material in between two molds, each having the imprint of the spacing structures;
step c) is achieved by rubbing said first and second main surfaces along the corresponding predetermined alignment directions;
steps a), b) and c) are achieved simultaneously by embossing a polymer material in between the two said molds, each having the imprint of said spacing structures as well as the imprint of nanostructures located between the imprint of said spacing structures.

The invention finds a particularly interesting application in a spatial phase modulator comprising
a thin film according to the invention,
at least two electrodes sandwiching said thin film, and
liquid crystals filling the space delimited between the first zone of each of the first and second main surfaces of the thin film, and the corresponding electrode.

### DETAILED DESCRIPTION OF EXAMPLE(S)

The following description, enriched with joint drawings that should be taken as non limitative examples, will help understand the invention and figure out how it can be realized.

On joint drawings:

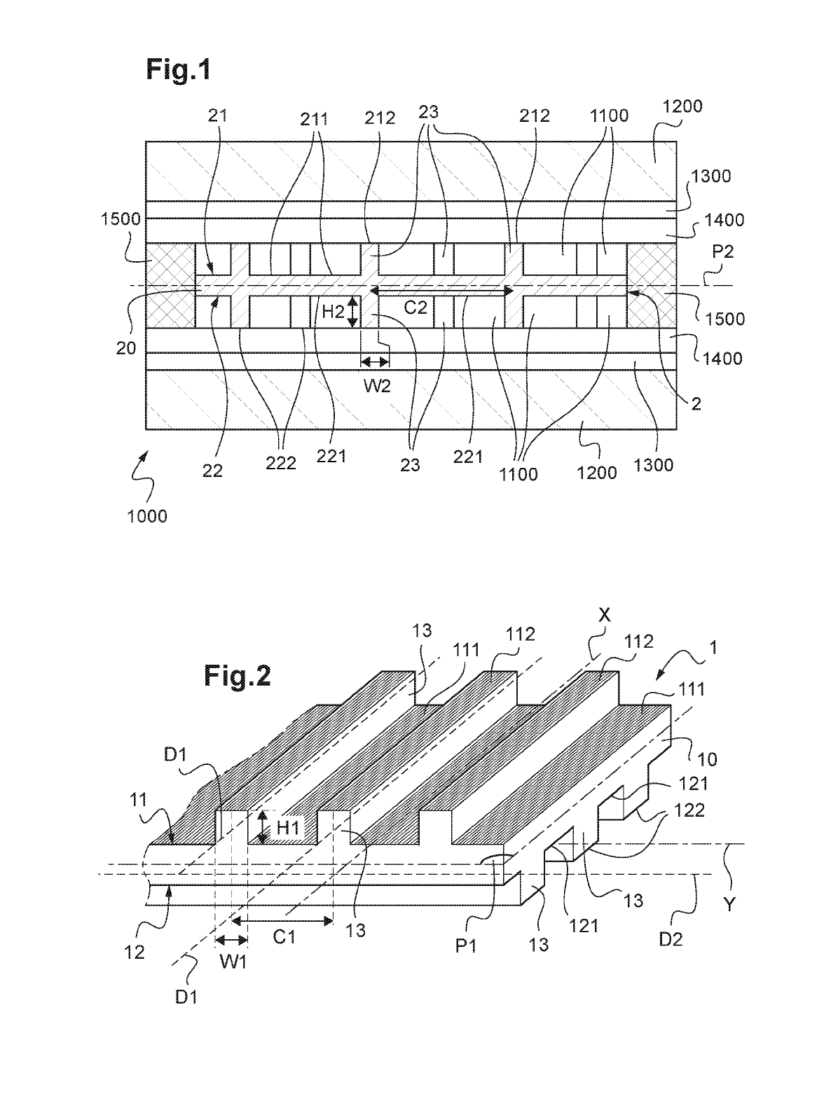

FIG. 1 is a side cross-sectional view of a spatial phase modulator according to the invention;

FIG. 2 is a view in perspective of a first embodiment of a thin film according to the invention;

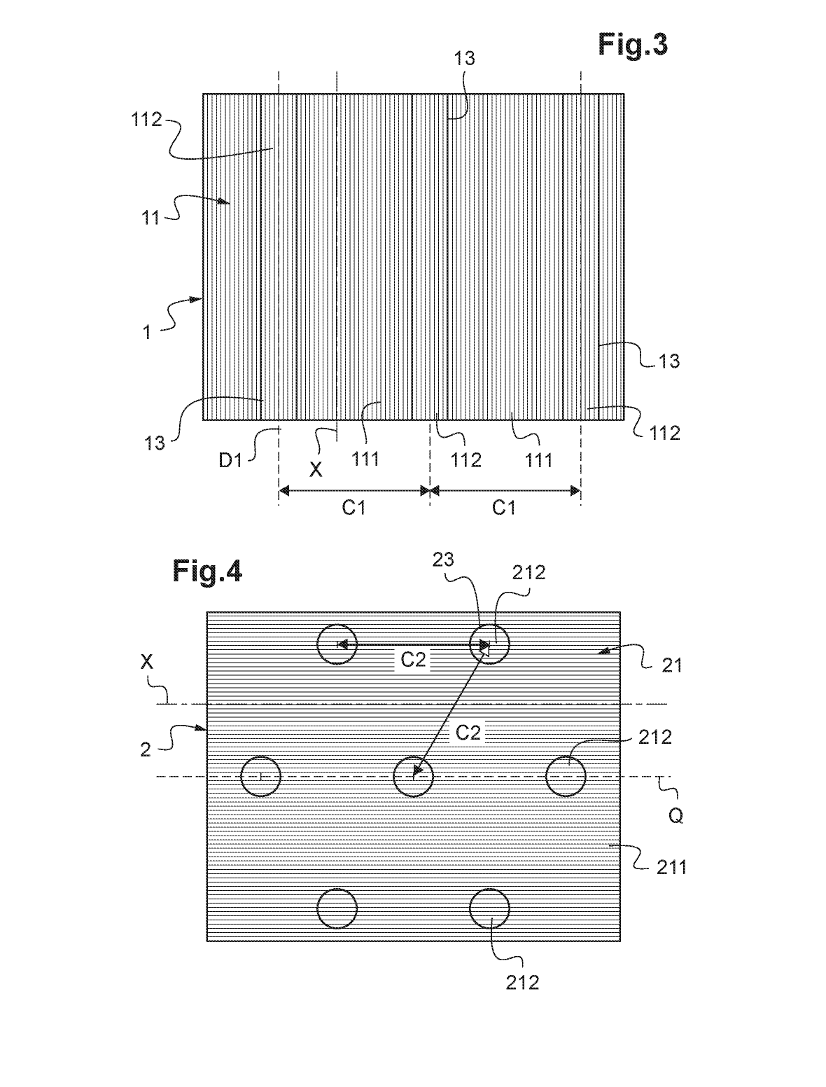

FIG. 3 is a top view of the thin film represented on FIG. 2;

FIG. 4 is a top view of a second embodiment of a thin film according to the invention;

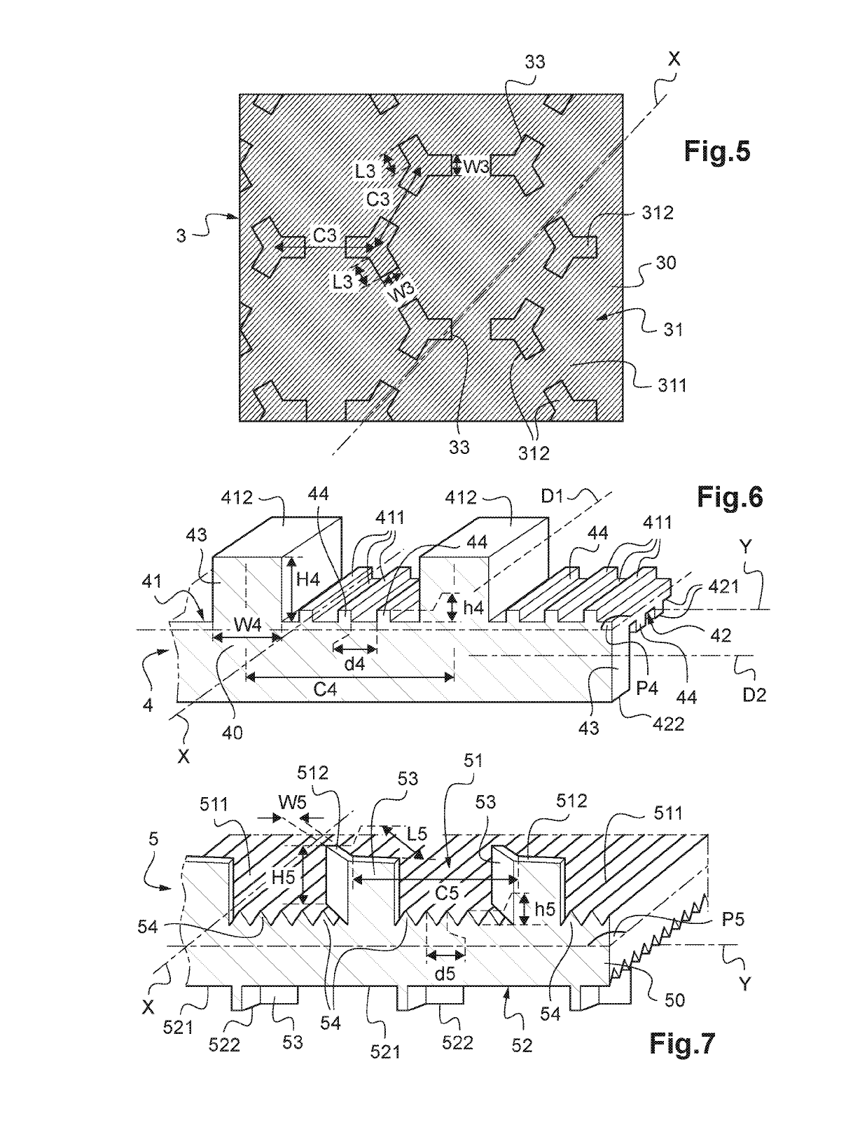

FIG. 5 is a top view of a third embodiment of a thin film according to the invention;

FIG. 6 is a cross-sectional view in perspective of a fourth embodiment of a thin film according to the invention; and,

FIG. 7 is a cross-sectional view in perspective of a fifth embodiment of a thin film according to the invention.

A spatial phase modulator according to the invention forms a dual cell of liquid crystals. This spatial phase modulator according to the invention is an optical article.

The spatial phase modulator according to the invention comprises a thin film 1; 2; 3; 4; 5 forming an intermediate layer in this spatial phase modulator, and, on each side of this thin film 1; 2; 3; 4; 5, liquid crystals sandwiched against an electrode. More precisely, the liquid crystals are filling the spaces delimited between the thin film 1; 2; 3; 4; 5 and two layer stacks, each layer stack comprising an electrode and being located on one or the other side of this thin film 1; 2; 3; 4; 5.

On FIG. 1, we have represented such a spatial phase modulator 1000.

In this spatial phase modulator 1000, each layer stack on each side of the thin film 2 comprises, starting from said thin film 2, an alignment layer 1400, the electrode 1300, and a substrate 1200.

The alignment layers 1400, the electrodes 1300 and the substrates 1200 are not central to the invention and they are known in the art, As a consequence, they will not be described in great details.

In practice, each alignment layer 1400 is made of a polymer material film able to align liquid crystals along a particular alignment direction. Here the alignment layer 1400 is made of a polyimide polymer.

Alternatively, the alignment layer 1400 could be made of any material able to induce alignment of liquid crystals, such as polycarbonate or cyclic-olefin polymers for instance.

The polymer material forming the alignment layer 1400 is treated in order to give it its alignment properties, This treatment may consist in stretching the film of polymer material forming the alignment layer along the direction of alignment, or rubbing this film along the alignment direction,

Each electrode 1300 is made of a conductive material, which is here indium-tin-oxide.

Of course, each electrode 1300 of each layer stack is not necessarily made of the same conductive material.

We consider as an “electrode” 1300 either a single plain electrode, or a multitude of electrodes forming a patchwork of electrodes. In other words, the spatial phase modulator 1000 comprises, on each side of the thin film 2, at least one electrode 1300.

Here, each substrate 1200 is a glass substrate 1200 able to support and to protect the whole structure of the dual cell.

As represented on FIG. 1, both layer stacks on both sides of the thin film 2 are glued together with a glue 1500 so that the thin film 2 and the liquid crystals 1100 are sealed between both layer stacks to form the dual cell of liquid crystals.

On FIGS. 2 to 7, we have represented different embodiments of the thin film 1; 2; 3; 4; 5 according to the invention.

In particular, on FIGS. 2 and 3 we have represented a first embodiment of the thin film 1; on FIG. 4, we have represented a second embodiment of the thin film 2; on FIG. 5, we have represented a third embodiment of the thin film 3; on FIG. 6 we have represented a fourth embodiment of the thin film 4; and on FIG. 7, we have represented a fifth embodiment of the thin film 5.

Regardless of the embodiment, the thin film 1; 2; 3; 4; 5 according to the invention is preferably made of a colorless polymer material.

Preferably, the thin film 1; 2; 3; 4; 5 according to the invention is made of a thermoplastic polymer.

In a preferable way, the thin film 1; 2; 3; 4; 5 according to the invention is made of a polyimide polymer. Preferably, this polyimide polymer has a glass transition temperature lower than 250 Celsius degrees (° C.).

More specifically, the glass transition temperature of the polyimide polymer used for the different embodiments of the thin film 1; 2; 3; 4; 5 is in the range comprised between 100° C. and 220° C., preferably around 150° C. or 180 ° C.

It is to be understood that the polyimide polymer used to obtain the alignment layers 1400 of the spatial phase modulator 1000 may be of a different type than the polyimide polymer used to manufacture the thin film 1; 2; 3; 4; 5. In particular, it may exhibit a glass transition temperature value outside the above-described range.

Advantageously, as explained in more details later on, the polyimide polymer used here has a relatively low glass transition temperature that makes possible the embossing of the thin film to create structures on a micrometric or even nanometric scale.

Moreover, the refractive index of the polyimide polymer used here is approximatively 1.74, and its dielectric constant is around 3.4.

Advantageously, as explained in more details later on, the polyimide polymer used to make the thin film 1; 2; 3; 4; 5 according to the invention has a relatively high dielectric constant, which suggests that a lower voltage can be applied to the spatial phase modulator 1000.

The person skilled in the art could also use, a hybrid type polyimide, such as the one quoted in Gwag et al, J. of Applied Physics 102 063501 (2007), that is to say the hybrid type polyimide obtained by synthesizing and baking a polyamic acid, a polyesteramic acid and an epoxy resin, with a solvent mix made of N-methylpyrrolidone with ethylene glycol butyl ether and butyrolactone within a weight ratio of 59/33/8. However, the person skilled in the art would know to use other polyimide-based polymers of Tg smaller than 200° C. or 220° C.

As an alternative, the thin film according to the invention could be made of any thermoplastic polymer material able to induce alignment of liquid crystals, such as polycarbonate or cyclic-olefin polymers for instance. For example, the thin film could be made of the cyclic-olefin polymer called under the commercial name ZEONOR® of reference ZF14-100 sold by the company ZEON® Corp.

Regardless of the embodiment of the thin film 1; 2; 3; 4; 5, the thin film 1; 2; 3; 4; 5 according to the invention essentially comprises a main body 10; 20; 30; 40; 50 limited by a first main surface 11; 21; 31; 41; 51 and by a second main surface 12; 22; 42; 52 opposed to the first main surface 11; 21; 31; 41; 51.

In other words, the first and second main surfaces 11; 21; 31; 41; 51, 12; 22; 42; 52 are facing each other.

It is to be noticed that the second surface, and the elements it comprises, of the third embodiment of the thin film 3 according to the invention are not visible on the figures, as we have represented a top view only of said thin film 3. Except otherwise stated features, the description of the second surfaces 12; 22; 42; 52 of the other embodiments of the thin films 1; 2; 4; 5 also applies to this third embodiment.

A median plane P1; P2; P4; P5 of the main body 10; 20; 30; 40; 50 is represented on FIGS. 1, 2, 6 and 7. This median plane P1; P2; P4; P5 is globally mainly parallel to said first and second main surfaces 11, 12; 21, 22; 31; 41, 42; 51, 52, and it divides the main body 10; 20; 40; 50 into two pieces of same smaller thickness, the thickness being the distance taken in a direction perpendicular to this median plane P1; P2; P4; P5.

Notably, said first and second main surfaces 11, 12; 21, 22; 31; 41, 42; 51, 52 both comprise a first zone 111, 121; 211, 221; 311; 411, 421; 511, 521 exhibiting alignment properties for aligning liquid crystals 1100 along a predetermined alignment direction X, Y and a second zone 112, 122; 212, 222; 312; 412, 422; 512, 522 forming spacing structures 13; 23; 33; 43; 53 extending in projection from the first zone 111, 121; 211, 221; 311; 411, 421; 511, 521.

As represented on FIGS. 1 to 7, the first zone 111; 211; 311; 411; 511, of the first main surface 11; 21; 31; 41; 51 lies between the spacing structures 13; 23; 33; 43; 53 of said first main surface 11; 21; 31; 41; 51.

It is the same for the first zone 121; 221; 421; 521 of the second main surface 12; 22; 42; 52.

Beneficially, the thin film 1; 2; 3; 4; 5 according to the invention, shows a ratio between the total surface occupied by the first zone 111, 121; 211, 221; 311; 411, 421; 511, 521 and the total surface occupied by the spacing structures 13; 23; 33; 43; 53 that ranges from 1 to 200, preferably from 5 to 60. More specifically, said ratio could be about 10, about 20 or about 30.

The surface occupied by the spacing structures is the surface of the base of the spacing structures measured in a mean plane of the first zone of the corresponding first or second surface, said mean plane of the first zone being globally parallel to the median plane of the main body.

In other words, on each first and second main surfaces 11, 12; 21, 22; 31; 41, 42; 51, 52, the surface occupied by the first zone 111, 121; 211, 221; 311; 411, 421; 511, 521 is from 1 to 200 times greater than the surface occupied by the spacing structures 13; 23; 33; 43; 53.

Thus, advantageously, the thin film 1; 2; 3; 4; 5 according to the invention is able, all at once, to align liquid crystals 1100 in its vicinity, thanks to the first zones 111, 121; 211, 221; 311; 411, 421; 511, 521 of its first and second main surfaces 11, 12; 21, 22; 31; 41, 42; 51, 52, and to control the height of the layers of liquid crystals 1100 in the spatial phase modulator 1000.

Beneficially, the first zone 111; 211; 311; 411; 511 of the first main surface 11; 21; 31; 41; 51 of the thin film 1; 2; 3; 4; 5 according to the invention is able to align liquid crystals along a first predetermined alignment direction X, while the first zone 121; 221; 421; 521 of the second main surface 12; 22; 42; 52 of the thin film 1; 2; 3; 4; 5 according to the invention is able to align liquid crystals along a second predetermined alignment direction Y different from the first predetermined alignment direction X.

Preferably, as represented on FIG. 2, said first and second predetermined alignment directions X; Y are perpendicular to each other, and each first and second predetermined alignment direction X; Y belongs to a plane parallel to said median plane P1; P2; P4; P5 of the main body 10; 20; 30; 40; 50,

The second predetermined alignment direction Y is not visible on FIGS. 3, 4 and 5 as they only show the first main surface 11; 21; 31 of the thin film 1; 2; 3.

Regardless of the embodiment of the thin film 1; 2; 3; 4; 5 according to the invention, the spacing structures 13; 23; 33; 43; 53 can be seen as protuberances extending away from the median plane P1; P2; P4; P5 of the main body 10; 20; 30; 40; 50, in a direction globally perpendicular to this median plane P1; P2; P4; P5.

Preferably, the spacing structures 13; 23; 33; 43; 53 of the first and second surfaces 11, 12; 21, 22; 31; 41, 42; 51, 52 have the same dimensions. Therefore, the median plane P1; P2; P4; P5 of the main body 10; 20; 30; 40; 50 is also the median plane of the thin film.

The spacing structures 13; 23; 33; 43; 53 extend also perpendicularly to the mean plane of the first zone 111, 121; 211, 221; 311; 411, 421; 511 521 of the corresponding first or second surface 11, 12 ; 21, 22; 31; 41, 42; 51, 52.

As a consequence, one should understand that the first and second main surfaces 11, 12; 21, 22; 31; 41, 42; 51, 52 are not flat as they follow said protuberances.

Thus, as represented on FIGS. 1, 2, 6 and 7, first and second main surfaces 11, 12; 21, 22; 31; 41, 42; 51, 52 are opposed to each other as they sandwich the main body 10; 20; 30; 40; 50 of median plane P1; P2; P4; P5, the spacing structures 13; 23; 33; 43; 53 of the first main surface 11; 21; 31; 41; 51 extending in a direction opposed to the one of the spacing structures 13; 23; 33; 43; 53 of the second main surface 12; 22; 42; 52.

In the final optical article, here the spatial phase modulator 1000, each layer stack rests on the free ends of the spacing structures 13; 23; 33; 43; 53 of the first main surface 11; 21; 31; 41; 51 on one side, and on the free ends of the spacing structures 13; 23; 33; 43; 53 of the second main surface 12; 22; 42; 52 on the other side of the thin film 1; 2; 3; 4; 5.

As explained later on, the spacing structures are formed in a way that ensures that they exhibit a uniform height, The height of the spacing structures may be defined as their dimension between the mean plane of the first zone of the corresponding first or second main surface and the free end of the spacing structure, measured in a direction perpendicular to the median plane of the main body.

In a beneficial way, the spacing structures 13; 23; 33; 43; 53 are therefore adapted to control precisely the thickness of the layers of liquid crystals 1100 in the spatial phase modulator 1000.

Moreover, thanks to the spacing structures 13; 23; 33; 43; 53 the thickness of the layers of liquid crystals 1100 can be reduced without affecting the height homogeneity of said layers of liquid crystals 1100.

Regardless of the embodiment of the thin film 1; 2; 3; 4; 5 according to the invention, the spacing structures 13; 23; 33; 43; 53 are either shaped as straight walls 13; 43 or shaped as pillars 23; 33; 53.

As represented on FIGS. 2, 3 and 6, a spacing structure shaped as a straight wall 13; 43 extends from one end to another of the first main surface 11; 41 along a first main direction D1, and from one end to another of the second main surface 12; 42; along a second main direction D2.

The first main directions D1 along which the spacing structures 13; 43 of the first main surface 11; 41 extend are parallel to one another. Similarly, the second main directions D2 along which the spacing structures 13; 43 of the second main surface 12; 42 extend are parallel to one another.

Preferably, the first main direction D1 of the spacing structures 13; 43 of the first main surface 11; 41 is perpendicular to the second main direction D2 of the spacing structures 13; 43 of the second main surface 12; 42.

Consequently, the spacing structures 13; 43 shaped as straight walls delimit several portions of the first zone 111, 121; 411, 421 of the first and second main surfaces 11; 41.

For instance, it can be seen on FIG. 3 representing a top view of the first embodiment of the thin film 1 that the three spacing structures 13 shaped as straight walls delimit four portions of the first zone 111 of the first main surface 11.

Similarly, as represented on FIG. 6, the two spacing structures 43 delimit two portions of the first zones 411 of the first main surface 41.

In a beneficial way, the distance between two spacing structures shaped as straight lines 13; 43 can be precisely chosen so that each future layer of liquid crystals 1100 in the spatial phase modulator 1000 has a homogeneous height.

As represented on FIGS. 4, 5 and 7, a spacing structure shaped as a pillar 23; 33; 53 extends locally in the first main surface 21; 31; 51, respectively in the second main surface 22; 52.

In other words, with such spacing structures shaped as pillars 23; 33; 53, the first main surface 21; 31; 51, respectively the second main surface 22; 52, comprises a continuous first zone 211; 311; 511, respectively 221; 521. For instance we can see on FIGS. 4 and 5 this kind of first zone 211; 311.

In terms of shape, the pillars 23; 33; 53 can be cylindrical plots 23, as represented on FIG. 4, or three-branches plots 33; 53, as represented on FIGS. 5 and 7.

The three-branches plots 33; 53 comprise three branches extending radially in a section parallel to the median plane P5 of the thin film 3; 5.

Beneficially, the three-branches plots 33; 53 are mechanically stronger than the cylindrical plots. Moreover, three-branches plots 33; 53 enable cell-like structures.

However, the pillars are not limited to these shapes. Alternatively, one could imagine pillars shaped as triangles from a top view, that is to say shaped as triangular plots, or as dash walls, that is to say as rectangular plots, or even as fish scales from a top view, that is to say as arc of circle plots, such as the shapes described in patents EP1904885, EP1904887, EP11727211, or variations of such shapes with non-continuous walls.

The spacing structures shaped as pillars 23; 33; 53 are regularly spread over said first and second main surfaces 211, 221; 311; 511, 521 in order to, in a beneficial way, ensure that each future layer of liquid crystals 1100 in the spatial phase modulator 1000 has a homogeneous height.

Regardless of the nature, straight wall or pillar, of the spacing structures 13; 23; 33; 43; 53, in terms of scale, in a direction perpendicular to the median plane P1; P2; P4; P5 of the main body 10; 20; 30; 40; 50, the said spacing structures 13; 23; 33; 43; 53 have a height H1; H2; H4; H5 that ranges from 1 micrometer to 100 micrometers, preferably from 5 micrometers to 50 micrometers, more preferably from 10 micrometers to 30 micrometers, for example about 20 micrometers.

Indeed, on one hand, a greater thickness of the layers of liquid crystals 1100 sandwiched in the spatial phase modulator 1000 could improve the amplitude of the phase modulation created by said spatial phase modulator 1000. However, on the other hand, the greater the thickness of these layers of liquid crystals 1100, the higher the voltage to be generated between the two electrodes 1300 for aligning said liquid crystals 1100.

Here, in the different embodiments of the thin film 1; 2; 3; 4; 5, in a direction perpendicular to the median plane P1; P2; P4; P5 of the main body 10; 20; 30; 40; 50, the height H1; H2; H4; H5 of the spacing structures is approximately 20 micrometers.

Regardless of the embodiment of the thin film 1; 2; 3; 4; 5, said thin film 1; 2; 3; 4; 5 is manufactured according to a method that both creates the spacing structures 13; 23; 33; 43; 53 and provides to the first zones 111, 211; 311; 411; 511, 121; 221; 421; 521 of said first and second main surfaces 11; 21; 31; 41; 51, 12; 22; 42; 52 its alignment properties.

According to the invention, the method for manufacturing the thin film 1; 2; 3; 4; 5 comprises the following steps:

a) providing the main body 10; 20; 30; 40;50 with said first and second main surfaces 11, 12; 21, 22; 31; 41, 42; 51, 52,

b) providing said first and second main surfaces 11, 12; 21, 22; 31; 41, 42; 51, 52 with spacing structures 13; 23; 33; 43; 53, thereby defining the second zone 112, 122; 212, 222; 312; 412, 422; 512, 522 of said first and second main surfaces 11, 12; 21, 22; 31; 41, 42; 51, 52,

c) providing the part of the first and second main surfaces 11, 12; 21, 22; 31; 41, 42; 51, 52 located between said spacing structures 13; 23; 33; 43; 53 with alignment properties for aligning liquid crystals 1100, thereby defining the first zone 111, 121; 211, 221; 311; 411, 421; 511, 521 of said first and second main surfaces 11, 12; 21, 22; 31; 41, 42; 51, 52.

Regardless of the embodiments of the thin film, to achieve at least two of these steps, namely step a) and b), an operator deforms the polymer material, which is here the polyimide polymer, using pressure and thermal stresses.

This deforming process is better known as “embossing process” or “thermal nanoimprint process”.

In particular, the operator achieves steps a) and b) by embossing the polyimide polymer in between two molds in order to imprint both the first and second surfaces 11, 12; 21, 22; 31; 41, 42; 51, 52 of the thin film 1; 2; 3; 4; 5 with their respective spacing structures 13; 23; 33; 43; 53.

Of course, the operator uses two molds that have the imprint of the appropriate spacing structures 13; 23; 33; 43; 53, that is to say any of the spacing structures presented before.

More precisely, the molds used to manufacture the first and fourth embodiments of the thin film 1; 4 comprise the imprints of straight walls. The depth of these imprints, corresponding to the height H1; H4 of the spacing structures 13; 43, is 20 micrometers. The width of the imprints, corresponding to a width W1; W4 of the spacing structures 13; 43, measured in a plane parallel to the median plane P1; P4 of the main body 10; 40, is 10 micrometers (FIGS. 2 and 6). Two centered longitudinal lines of two consecutive imprints are separated by approximately 210 micrometers in the first embodiment, corresponding to the distance C1 separating two consecutive spacing structures 13 center to center (FIG. 2), Two centered longitudinal lines of two consecutive imprints are separated by approximately 410 micrometers in the fourth embodiment, corresponding to the distance C4 separating two consecutive spacing structures 43 center to center (FIG. 6).

The molds to manufacture the second embodiment of the thin film 2 comprise the imprints of cylindrical plots. The depth of the imprints, corresponding to the height H2 of the spacing structures 23, is 20 micrometers. The diameter of the imprints, corresponding to the diameter W2 of the spacing structures 23, is 20 micrometers. The centers of two consecutive imprints are separated by approximately 220 micrometers, corresponding to the distance C2 separating two consecutive spacing structures 23 center to center (FIG. 1).

The molds to manufacture the third and fifth embodiments of the thin film 3; 5 comprise the imprints of three-branches plots. The depth of the imprints, corresponding to the height H5 of the spacing structures 33; 53, is 20 micrometers (FIGS. 5 and 7). The length of each branch of the imprints, corresponding to a length L3; L5 of each branch of the spacing structures 33; 53, is 40 micrometers. The width of each branch of the imprints, corresponding to a width W3; W5 of each branch of the spacing structures 33; 53, is approximately 10 micrometers. The centers of two consecutive imprints are separated by approximately 120 micrometers in the third embodiment, corresponding to the distance C3 separating two consecutive spacing structures 33 center to center, and by approximately 170 micrometers in the fifth embodiment, corresponding to the distance C5 separating two consecutive spacing structures 53 center to center. In particular the free end of a branch from one three-branches plot may be distant from the free end of a branch of another three-branches plot by as close as 80 micrometers or even 40 micrometers.

Of course, the person skilled in the art could make the molds used to manufacture any of the first, second, third, fourth and fifth embodiments of the thin film, with the centers consecutive imprints separated by 50 micrometers, 100 micrometers, 300 micrometers or even 500 micrometers depending on the rigidity and thickness of both the thin film to be obtained and the layer stacks to be sandwiched between this thin film and the electrodes.

The molds could be made of any material strong enough to withstand repetitive pressure and thermal stresses, for example of silicon, fused silica, Nickel or silicium oxide, and may be obtained by any method known of the person skilled in the art.

For example, they can be obtained by standard semi conductor processes, such as lithography or engraving process with electron-beams. Such methods are known of the person skilled in the art and will not be detailed any further. Of course, the methods to obtain the molds are not limited to the one previously mentioned.

During the embossing of the polymer material, the operator heats the polyimide polymer up to a temperature that ranges from 180° C. to 250° C., preferably from 200° C. to 220° C. This heating of the polyimide polymer can be done at a rate of about 10 Celsius degrees per minute (° C./min) for instance.

Then, the operator applies on the molds a pressure equivalent to 500 Newton to 1000 Newton. Here, the size of the molds is around 2 square centimeters.

The operator maintains said pressure for 5 minutes before he decreases the temperature of the polyimide polymer down to approximately 120° C. Here, the rate for this temperature decrease is around 15° C./min.

The operator then releases the pressure, and releases the thin film 1; 2; 3; 4; 5 from the molds when its temperature is approximately between 80° C. and 20° C.

In a beneficial way, the method for manufacturing said thin film 1; 2; 3; 4; 5 according to the invention is simple as at least two steps can be achieved simultaneously.

Moreover, this method according to the invention is well adapted to shape the polymer material used here, namely the polyimide polymer, without chemically destroying it.

On top of that, this method according to the invention provides the thin films 1; 2; 3; 4; 5 according to the invention with spacing structures of precise height.

The various embodiments of the thin film 1; 2; 3; 4; 5 described here can be split into a first and a second family, depending on the way said first zone 111, 121; 211, 221; 311; 411, 421; 511, 521 is manufactured in step c).

In a first family of embodiments of the thin film 1; 2; 3 according to the invention, the alignment properties of the first zone 111, 121; 211, 221; 311 of at least one of said first and second main surfaces 11, 12; 21, 22; 31 are obtained, in step c), by rubbing said first zone 111, 121; 211, 221; 311 along the corresponding predetermined alignment direction X, Y.

This first family includes, in particular, the first, second and third embodiments of the thin film 1; 2; 3 represented, respectively, on FIGS. 2 and 3, on FIGS. 1 and 4, and on FIG. 5.

The rubbing of the first zone corresponds to an industrial process described below in more details. The alignment properties conferred by this rubbing process to said first zone 111, 121; 211, 221; 311 come from an alignment of the polymer chains of the polyimide polymer and/or from nano-scratches along said corresponding predetermined alignment direction X, Y generated by the rubbing of the surface of the polyimide polymer.

These aligned polymer chains and/or nano-scratches create a preferential physical interaction between the first zone 111, 121; 211, 221; 311 and the liquid crystals 1100. Thus, the liquid crystals 1100 are forced to adopt a preferential orientation when they are in the vicinity of the first zone 111, 121; 211, 221; 311 of said first and second main surfaces 11, 12; 21, 22; 31, that is to say that liquid crystals 1100 are forced to align along the first predetermined alignment direction X on the first main surface 11; 21; 31, and along the second predetermined alignment direction Y on the second main surface 12; 22.

According to a first embodiment of the method for manufacturing the thin film 1; 2; 3, used for manufacturing any of the embodiments of the first family of embodiments of the thin film 1; 2; 3 according to the invention, the operator achieves steps a) and b) as stated before, that is to say, simultaneously by embossing the polyimide polymer in between two molds, each mold having the imprint of the spacing structures 13; 23; 33.

These molds have been described in details above.

Then, the operator achieves step c) to give to the first zone 111, 121; 211, 221; 311 of said first and second main surfaces 11, 12; 21, 22; 31 its ability to align liquid crystals by rubbing said first and second main surfaces 11, 12; 21, 22; 31 along their corresponding predetermined alignment directions X, Y.

In practice, the operator achieves this rubbing with a rubbing machine equipped with a cloth. The rubbing can also be seen, in an equivalent way, as a soft brushing.

The operator uses here a cloth made of cotton, the diameter of the fibers can, for instance, be between 1.2 and 1.4 deniers, the pile yarn diameter being around 266 deniers, the number of piles per square inches being around 2000, and the number of fibers per square centimeters being around 63000. The denier is a measurement unit in the Textile Industry that corresponds to the weight in grams of 9000 meters of fiber.

Such a cloth is for instance sold by Taenaka, under the reference MK0012.

For example, the operator sets the parameters of the rubbing machine as follow: the roll speed is around 200 rounds per minutes, the stage speed is around 10 millimeters per second, and the indentation depth is around 0.3 millimeters.

The operators rubs first the first main surface 11; 21; 31 of the thin film 1; 2; 3 along the first predetermined alignment direction X.

Then, the operator flips over the thin film 1; 2; 3 so that said thin film 1; 2; 3 lies on the spacing structures 13; 23; 33 of the first main surface 11; 21; 31.

The operator rubs the second main surface 12; 22 along said second predetermined alignment direction Y, that is to say along a direction orthogonal to said first predetermined alignment direction X.

Advantageously, the operator does not damage the first zone 111; 211; 311 of the first main surface 11; 21; 31 when he flips over the thin film 1; 2; 3 as said thin film 1; 2; 3 lies on the free ends of the spacing structures 13; 23; 33. The operator can therefore rub both first and second surfaces of the thin film 1; 2; 3 without destroying the surface rubbed in the first place.

Of course, the operator can alternatively rub the first zone 121; 221 of the second main surface 12; 22 before he rubs the first zone 111; 221; 311 of the first main surface 11; 21; 31.

More precisely, in the first embodiment of the thin film 1, which is the preferred embodiment of the first family of embodiments, represented on FIGS. 2 and 3, the spacing structures 13 of the first and second main surfaces 11, 12, are straight walls extending along the corresponding first and second main directions D1, D2. The width W1 of these straight walls is 10 micrometers and the distance C1 separating two straight walls is about 210 micrometers, center to center.

The ratio between the surface occupied by the first zone 111, 121 and the surface occupied by the spacing structures 13 in the first embodiment of the thin film 1 is about 20.

The spacing structures 13 are obtained by embossing as described before.

The first and second predetermined alignment direction X, Y are parallel to the corresponding first or second main direction D1, D2 along which the spacing structures 13 of the corresponding first or second main surfaces 11, 12 extend.

Indeed, when the first or second main direction D1, D2 of the spacing structures 13 of the first or second main surface 11, 12 is parallel to the corresponding first or second predetermined alignment direction X, Y, the rubbing may be applied to all of the first or second main surface 11, 12 situated between the spacing structures 13.

In other words, in a beneficial way, the part of the first zone 111 that will undergo said rubbing is thus maximum.

On the contrary, in the case where the predetermined alignment directions X, Y are not parallel to the direction along which the spacing structures extend, or in the case where the spacing structures do not extend along a privileged direction, as in the case of spacing structures being pillars, a part of the surface located between the spacing structures and lying behind each spacing structure in the direction of the rubbing may not be rubbed. This part of the surface located between the spacing structures therefore does not exhibit alignment properties.

In the second embodiment of the thin film 2, represented on FIGS. 1 and 4, the spacing structures 23 of said first and second mains surfaces 21, 22 are cylindrical plots 23 that have a diameter W2 of approximately 20 micrometers. The distance C2 separating two consecutive plots 23 is about 220 micrometers, center to center, and the plots 23 are arranged in about an hexagonal pattern.

The ratio between the surface occupied by the first zone 211, 221 and the surface occupied by the spacing structures 23 in the second embodiment of the thin film 2 is about 133.

FIG. 1 shows the thin film 2 of FIG. 4 cut along an axis of cut 0. As shown on FIG. 1, in the thin film 2 of this example, the cylindrical plot 23 of the first and second main surfaces 21 are symmetrical relative to the median plane.

Alternatively, the cylindrical plot 23 of said first main surface 21 could be positioned, on a top view of the thin film 2, in between the cylindrical plots 23 of said second main surface 22.

According to another alternative, the spacing structures of said first and second main surfaces could have different shapes, that is to say for instance cylindrical plots on the first main surface, and triangular plots on the second main surface. However, the height of the spacing structures 23 of the first and second main surfaces 21, 22 are preferably the same.

For manufacturing the second embodiment of the thin film 2 of FIGS. 1 and 4, there is no preferential direction for the first predetermined alignment direction X. Therefore, in step c), rubbing may be applied to the first zone 211 of the first surface 21 of the thin film 2 along any direction.

However, in step c), the second predetermined alignment direction Y of the first zone 221 of the second surface 22 is preferably perpendicular to the first predetermined alignment direction X.

In the third embodiment of the thin film 3, represented on FIG. 5, the spacing structures 33 of said first and second main surfaces 31 are three branches plots 33. The width W3 of each branch is 10 micrometers and the length L3 of each branch is 40 micrometers.

The distance C3 separating two consecutive three branches plots 33 is about 120 micrometers, center to center.

The ratio between the surface occupied by the first zone 311 and the surface occupied by the spacing structures 33 in the third embodiment of the thin film 3 is about 15.

As for the second embodiment of the thin film 2, the spacing structures 33 can be symmetrical relative to the median plane, that is to say between the first main surface 31 and the second main surface, but not necessarily.

Here again, in step c), there is no preferential direction for the first predetermined alignment direction X. However, the second predetermined alignment direction Y is chosen perpendicular to the first predetermined alignment direction X.

In the second family of embodiments of the thin film 4; 5 according to the invention, the first zone 411, 421; 511, 521 of at least one of said first and second main surfaces 41, 42; 51, 52, provided in step c), comprises nanostructures 44; 54 that have an elongated shape along the corresponding predetermined alignment direction X, Y.

The second family includes the fourth and fifth embodiments of the thin film 4; 5 represented, respectively, on FIGS. 6 and 7.

Here, these nanostructures are obtained in step c) by embossing. Steps a), b) and c) are thus achieved simultaneously, by using adapted molds, as described later.

More precisely, said nanostructures 44; 54 are shaped as straight walls extending longitudinally along the first predetermined alignment direction X on the first main surface 41; 51, and along the second predetermined alignment direction Y on the second main surface 42; 52.

Alternatively, said nanostructures could also be shaped as dash straight walls.

In a direction perpendicular to the median plane P4; P5 of the main body 40; 50 the nanostructures 44; 54 have a height h4; h5 that ranges from 5 nanometers to 500 nanometers, preferably from 10 nanometers to 200 nanometers.

Moreover, the nanostructures 44; 54 are spaced apart from each other by a distance d4; d5 ranging from 100 nanometers to 2 micrometers in a direction parallel to the median plane P4, P5.

In the fourth embodiment of the thin film 4, the distance d4 between two rectangular nanostructures 44 is the width of a groove that lies between two rectangular nanostructures 44.

In the fifth embodiment of the thin film 5, the distance d5 between two triangular nanostructures 54 is the distance between the top of two consecutive triangular nanostructures 54.

As schematically represented on FIGS. 6 and 7, said nanostructures 44;

54 are much smaller than said spacing structures 43; 53 and their respective role regarding the spatial phase modulator 1000 is very different.

These nanostructures 44; 54 give its alignment properties to said first zone 411, 421; 511, 521.

These nanostructures 44; 54 create a preferential physical interaction between the first zone 411, 421; 511, 521 and the liquid crystals 1100. Thus, the liquid crystals 1100, when they are not stimulated by any electrical field, are forced to adopt a preferential orientation when they are in the vicinity of the first zone 411, 421; 511, 521 of said first and second main surfaces 41, 42; 51, 52, that is to say that liquid crystals 1100 are forced to align along the first predetermined alignment direction X on the first main surface 41; 51, and along the second predetermined alignment direction Y on the second main surface 42; 52.

In a beneficial way, the first zone 411, 421; 511, 521 comprising nanostructures 44; 54 is very homogeneous on said first and second main surfaces 41, 42; 51, 52 as it does not depend on the shape and/or position of the spacing structures 43; 53.

In the second embodiment of the method for manufacturing the thin film 4; 5 according to the invention, the operator achieves simultaneously steps a), b) and c) by embossing a polymer material, which is here the polyimide polymer, in between two other molds, each other mold having the imprint of said spacing structures 43; 53 as well as the imprint of nanostructures 44; 54 located between the imprint of said spacing structures 43; 53.

In other words, the two other molds are similar to the molds described in the first embodiment of the method except that they also have the imprint of nanostructures 44; 54 located between the imprint of said spacing structures 43; 53.

The molds may be obtained by any of the methods described earlier in reference to steps a) and b).

In a beneficial way, the second embodiment of the method according to the invention for manufacturing any embodiments of the second family of embodiments of the thin films 4; 5 is easily reproducible as the operator has to achieve only one main operation.

More precisely, in the fourth embodiment of the thin film 4 according to the invention, represented on FIG. 6, the nanostructures 44 are straight rectangular walls, and the spacing structures 43 are also straight rectangular walls, that is to say, walls with a rectangular cross-section, the cross-section being made in a plane perpendicular to the median plane P4 and perpendicular to the respective first an second predetermined alignment directions X, Y on the respective first and second main surfaces 41, 42.

In this fourth embodiment of the thin film 4, the width W4 of the spacing structures 43 is 10 micrometers. The distance C4 separating two consecutive spacing structures 43 is approximately 410 micrometers, center to center. The width W4 of the nanostructures 44 is about 400 nanometers. The distance d4 separating two consecutive nanostructures 44 is about 150 nanometers.

The ratio between the surface occupied by the first zone 411, 421 and the surface occupied by the spacing structures 43 in the fourth embodiment of the thin film 4 is about 40.

The first predetermined alignment direction X and the first main direction D1 along which the spacing structures 43 extend on the first main surface 41 are parallel. Similarly, the second predetermined alignment direction Y and the second main direction D2 along which the spacing structures 43 extend on the second main surface 42 are parallel.

However, the first predetermined alignment direction X, and with it the first main direction D1, is perpendicular to the second predetermined alignment direction Y, and with it to the second main direction D2.

The operator arranges carefully the molds so that the first main direction D1 and the first predetermined alignment direction X are perpendicular to the second main direction D2 and to the second predetermined alignment direction Y.

According to the fifth embodiment of the thin film 5 according to the invention, represented on FIG. 7, the nanostructures 54 are straight triangular walls, that is to say walls with a rectangular cross-section, and the spacing structures 53 are three branches plots.

In this fifth embodiment of the thin film 5, the width W5 of each branch of each spacing structure 53 is 10 micrometers and the length L5 of each branch of each spacing structure 53 is 40 micrometers. The distance C5 separating two consecutive spacing structures 53 is about 180 micrometers, center to center. The distance d5 separating two nanostructures 54 is around 200 nanometers. The height h5 of each nanostructure 54, that is to say its dimension in a direction perpendicular to the median plane P5 of the main body 50, is about 100 nanometers.

The ratio between the surface occupied by the first zone 511, 521 and the surface occupied by the spacing structures 53 in the fifth embodiment of the thin film 5 is about 35.

There is no preferential direction for the first and second predetermined alignment direction X, Y except that they are perpendicular to each other.

In particular, the operator arranges carefully the molds so that the first predetermined alignment direction X and the second predetermined alignment direction Y are perpendicular to each other.

In the light of the different embodiments detailed before, it appears that all the spacing structures 13; 23; 33; 43; 53 can be adapted to all the embodiments of the thin film 1; 2; 3; 4; 5. The only restrictive condition is that the first and/or second main direction D1; D2 of the elongated spacing structures should match the first and/or second predetermined alignment direction X, Y of the first zone 111, 121; 211, 221; 311; 411, 421; 511, 521 of said first and/or second main surface 11, 12; 21, 22; 31; 41, 42; 51, 52.

To manufacture the spatial phase modulator 1000 according to the invention, the operator sandwiches the thin film 1; 2; 3; 4; 5 according to the invention between the two layer stacks aforementioned.

To do so, the operator matches the alignment direction of each said alignment layer 1400 with the corresponding predetermined alignment direction X, Y of the first zone 111, 121; 211, 221; 311; 411, 421; 511, 521 of the first and second main surfaces 11, 12; 21, 22; 31; 41, 42; 51, 52.

In other words, the alignment direction of the corresponding alignment layer is parallel to the first predetermined alignment direction X, and the corresponding alignment layer is parallel to the second predetermined alignment direction Y.

More precisely, the alignment direction of the corresponding alignment layer and the first predetermined alignment direction X are opposed.

Similarly, the alignment direction of the corresponding alignment layer and the second predetermined alignment direction Y are opposed.

Due to the aforementioned imposed orientations of said liquid crystals 1100 in the vicinity of said alignment layers and of said first zone 111, 121; 211, 221; 311; 411, 421; 511, 521 of the first and second main surfaces 11, 12; 21, 22; 31; 41, 42; 51, 52 of the thin film 1; 2; 3; 4; 5, the layers of liquid crystals 1100 comprised in the spatial phase modulator 1000 exhibit a first index of refraction for a light beam passing through it.

When an electrical tension, or voltage, is applied between the two electrodes 1300 of the spatial phase modulator 1000, liquid crystals far from the alignment layers and from said first zone 111, 121; 211, 221; 311; 411, 421; 511, 521 of the first and second main surfaces 11, 12; 21, 22; 31; 41, 42; 51, 52 of the thin film 1; 2; 3; 4; 5 tend to align along a certain favorable direction along the electric field. Of course, to be able to align a majority of these liquid crystals 1100 along the electric field, the electrical tension should be strong enough to dominate the preferential physical interaction existing between these liquid crystals 1100 and the first zone 111, 121; 211, 221; 311; 411, 421; 511, 521 of said first and second main surfaces 11, 12; 21, 22; 31; 41, 42; 51, 52 of the thin film 1; 2; 3; 4; 5.

Despite said electrical tension applied between the two electrodes, the liquid crystals in the vicinity of said alignment layers and of said first zone 111, 121; 211, 221; 311; 411, 421; 511, 521 of the first and second main surfaces 11, 12; 21, 22; 31; 41, 42; 51, 52 of the thin film 1; 2; 3; 4; 5 do not completely align along the electric field as they have too strong interaction with said surfaces in their vicinity. As a consequence, the liquid crystals far from the above-mentioned surfaces beneficially recover their initial orientation when the electrical tension stops.

Thus, when said electrical tension is applied to the spatial phase modulator 1000, the layers of liquid crystals 1100 comprised in said spatial phase modulator 1000 exhibit a second index of refraction for a light beam passing through it.

This second index of refraction is variable and depends on the electrical tension applied in between the two electrodes 1300 of said spatial phase modulator 1000. In other words, said second index of refraction depends on the more or less good alignment of said liquid crystals 1100 along the electrical field created by the electrical tension.

In other word, when no tension is applied, the optical article shows a primary index.

When said electrical tension is applied non-uniformly to the spatial phase modulator 1000, the optical article shows an index profile varying between the primary index and the secondary index and light might be deviated depending on a the index profile and more particularly depending on the repartition of the index change through the whole optical article.

Beneficially, the thin film 1; 2; 3; 4; 5 according to the invention being rather thin, the electric tension applied to the spatial phase modulator 1000 to get a majority of liquid crystals aligned along the electrical field is smaller than with the intermediate layer of the previous art.

In a advantageous way, the thin film 1; 2; 3; 4; 5 according to the invention is multifunctional for an optical article such as a spatial phase modulator 1000 according to the invention, as, all at once, it aligns liquid crystals 1100 in one direction on one side, it aligns liquid crystals 1100 in another direction on the other side, and it provides a precise thickness to the layers of liquid crystals 1100 comprised in the optical article.

Moreover, the position of the spacing structures 13; 23; 33; 43; 53 of the second zones 112; 212; 312; 412; 512, 122; 222; 42; 522 being predetermined and precisely controlled, it ensures a good control of the thickness of each layer of liquid crystals 1100.

In addition, the thin film 1; 2; 3; 4; 5 according to the invention has a precisely controlled thickness and no birefringence properties.

At last, the thin film 1; 2; 3; 4; 5 according to this invention is simple to use and makes the manufacture of spatial phase modulators easier.

In an advantageous way, the thin film 1; 2; 3; 4; 5 according to the invention is rather thin, that is to say thinner than 50 micrometers, has a high dielectric constant, that is to say a dielectric constant bigger than 3 faradays per meter, and allows the spatial phase modulator 1000 according to the invention to have potentially thick layers of liquid crystals 1100, all three parameters being in favor of a polarization independent spatial phase modulator with a large phase shift.

1-16. (canceled)

17. A thin film forming an intermediate layer for an optical article including liquid crystals, the thin film comprising:
a main body limited by a first main surface and by a second main surface opposed to the first main surface,
the first and second main surfaces both comprising a first zone exhibiting alignment properties for aligning liquid crystals along a predetermined alignment direction and a second zone forming spacing structures extending in projection from the first zone.

18. A thin film according to claim 17, wherein the first zone of the first main surface aligns liquid crystals along a first predetermined alignment direction, and the first zone of the second main surface aligns liquid crystals along a second predetermined alignment direction different from the first predetermined alignment direction.

19. A thin film according to claim 17, wherein the first zone of at least one of the main surfaces comprises nanostructures having an elongated shape along the corresponding predetermined alignment direction.

20. A thin film according to claim 19, wherein the nanostructures are shaped as straight walls extending longitudinally along the corresponding predetermined alignment direction.

21. A thin film according to claim 19, wherein the nanostructures height in a direction perpendicular to a median plane of the main body ranges from 5 nanometers to 500 nanometers.

22. A thin film according to claim 19, wherein the nanostructures are spaced apart from each other by a distance ranging from 100 nanometers to 2 micrometers.

23. A thin film according to claim 17. wherein alignment properties of the first zone of at least one of the first and second main surfaces are obtained by rubbing the first zone along the corresponding predetermined alignment direction.

24. A thin film according to claim 17, wherein spacing structures of the second zone are shaped as straight walls or pillars.

25. A thin film according to claim 24, wherein the spacing structures height in a direction perpendicular to a median plane of the main body ranges from 1 micrometer to 100 micrometers.

26. A thin film according to claim 17, wherein the ratio between the surface occupied by the first zone to the surface occupied by the spacing structures ranges from 1 to 200.

27. A thin film according to claim 17, wherein the main body is made of a single piece of polymer material.

28. A method for manufacturing a thin film according to claim 17, comprising:
a) providing a main body with first and second main surfaces;
b) providing first and second main surfaces with spacing structures, thereby defining the second zone of the first and second main surfaces;
c) providing the part of the first and second main surfaces located between the spacing structures with alignment properties for aligning liquid crystals, thereby defining the first zone of the first and second main surfaces.

29. A method according to claim 28, wherein a) and b) are achieved simultaneously by embossing a polymer material in between two molds, each having the imprint of the spacing structures.

30. A method according to claim 28, wherein c) is achieved by rubbing the first and second main surfaces along the corresponding predetermined alignment directions.

31. A method according to claim 29, wherein a), b) and c) are achieved simultaneously by embossing a polymer material in between the two molds, each having the imprint of the spacing structures and the imprint of nanostructures located between the imprint of the spacing structures.

32. A spatial phase modulator comprising;
a thin film according to claim 17;
at least two electrodes sandwiching the thin film; and
liquid crystals filling the space delimited between the first zone of each of the first and second main surfaces of the thin film, and the corresponding electrode.
